(19) United States
(12) Patent Application Publication
(10) Pub. No.: US 2017/0175404 A1
(43) Pub. Date: Jun. 22, 2017

(54) ACOUSTICAL CEILING TILE REBATE TOOL

(71) Applicant: Stephen Christopher Marsiglia, Yorktown Heights, NY (US)

(72) Inventor: Stephen Christopher Marsiglia, Yorktown Heights, NY (US)

(21) Appl. No.: 14/974,197

(22) Filed: Dec. 18, 2015

(51) Int. Cl. E04F 21/00; B26D 7/22; B26D 7/26; B26D 7/18; E04B 9/04; B26D 1/03

(52) U.S. Cl. CPC E04F 21/0076; E04B 9/04; B26D 1/03; B26D 7/2628; B26D 7/1863; B26D 7/22

(57) ABSTRACT

An acoustical ceiling tile rebate tool which provides graduated knives into a support structure which guides the acoustical ceiling tile past the graduated knives on two passes so that a rebate is efficiently cut into the tile.

### BACKGROUND OF THE INVENTION

The invention is generally directed to an acoustical ceiling tile rebate tool used in connection with suspended or dropped ceilings in which the pre-cut tiles having a cut or recessed perimeter, which allows the tile to hang below the frame of the suspended or dropped ceiling. The rebate must be added where partial tiles are necessary at the perimeter of the rooms and at non-rectangular portions of the ceiling.

Generally, when a dropped ceiling is installed the installer first prepares the framework which is formed of a series of in metal strips which are suspended from the actual ceiling so as to hide duet work, electrical wires and lighting fixtures between the true ceiling and the flat dropped ceiling which forms the apparent ceiling of the room for users. Once the dropped ceiling framework is installed, the installer is able to note where tiles need to be cut to fit the frame, generally at the edges of the room. Preferred installation seems to balance the installation such that equal partial tiles are founds on opposite sides of the room so that the ceiling has a general balance. However, in lesser installations, the installer might choose to start the installation with a full tile against one wall. In either case, there will be a need to cut partial tiles to provide a finished dropped ceiling. The acoustical ceiling tiles come with a recessed edge around all four sides of the tile, which is called either a “recess,” “relief,” or the “rebate.” These cutout portions allow the tile to be supported on the recess portion, which results in the center of the tile hanging down below the frame to provide a cleaner look and feel to the suspended ceiling. However, when the tile cut to fit a smaller section, usually at the edges of the room, the cute in the tile will result in an edge that does not include a recess or rebate. Generally, cutting the new rebate on thee cut tile is a time consuming and difficult process.

Generally, the tile cutting of the recess or rebate is done on the job site and can often take a very substantial portion of the time necessary so install the dropped ceiling. Currently, hand· held tools for cutting rebates exist wherein the tool has to be moved relative to the tile with the user needing a steady hand to make the cut. Existing tile cutters have a single blade which makes cutting difficult and which wears out blades rapidly. Often, multiple passes are required for a single cut. Generally, to cut out a rebate, two separate cuts have to be made, one for the height of the rebate and one for the depth of the rebate. If the cuts are not done properly, an irregular edge to the rebate will exist and the tile will not hang properly.

Generally, using the small hand-held unit with a single blade, you work with it against the tile from the top and the side to slice out a rebate. An experienced ceiling mechanic can cut out a single rebate in about one minute or two on a single tile. The hand-held tool can be difficult to use and many times requires multiple passes to achieve a clean cut. Sometimes, because of the tool moving a bad cut is made and an entirely new tile has to be cut and rebated. Also, from a mechanical or functional aspect, working the tool against the tile is far less desirable than working the tile against the tool.

A second option for cutting the rebates in tiles is to use a cutter that is mounted on rails that slide down the tile as if it were being routed. This sort of tool is relatively expensive, and can be cumbersome and not conducive to use m the field. Accordingly there a need for an improved acoustical ceiling tile rebate cutting tool which achieves reliable rebates without the need for multiple passes to make the same cut, and does so in seconds. The tool is designed to be used at a job site and to significantly increase the reliability of cutting and speed of operation.

### SUMMARY OF THE INVENTION

The invention is generally directed to a multiple knife cutting tool which progressively cuts each dimension of the rebate with a single pass of the tile relative to the cutting tool.

The invention is also generally directed to an improved cutting tool which is easier to use than traditional hand-held tools.

Another object of the invention is to provide a cutting tool with graduated blades and a guide which because of its simplicity and functionality allows a novice to perform high quality rebates with little practice.

The invention is generally directed to an improved acoustical ceiling tile rebate tool which can be mounted on a flat, square surface, like a workbench or portable saw bench at a job site.

Still a further object of the invention is to provide for an improved acoustical ceiling tile rebate tool with a spring loaded snap over hood that protects the user from harm by the extended blade array when not in use.

Another object of the invention is to provide an improved acoustical ceiling tile rebate cutter in which the blades can be adjusted to graduated heights and to the ultimate depth or height of the rebate for the ceiling tile being used.

Yet another object of the invention is to provide an improved acoustical ceiling tile rebate device in which one can adjust the back guide to the depth needed for the tile's rebate.

Yet a further object of the invention is to provide an improved acoustical ceiling tile rebate tool which can be adjusted for appropriate height and depth of the rebate and then simplify the cutting of the rebate and extend the life of the cutting blades.

Yet still a further object of the invention is to provide an improved, stable and transportable acoustical ceiling tile rebate cutting tool which can be transported to a job site and screwed to an appropriate stand on site for easy and rapid use.

Still other objects and advantages of the invention will, is part, be obvious and will, in part, be apparent from the specification.

The invention accordingly comprises the features of construction, combinations of elements and arrangements of part and processes which will be exemplified in the constructions and processes as hereinafter set forth, and the scope of the invention will be indicated in the claims.

### BRIEF DESCRIPTION OF THE DRAWINGS

The present invention will now be described in more complete detail with frequent reference being made to the figures identified below.

FIG. 1 is the 3 dimensional drawing of the tool constructed in accordance with the main embodiment of the invention.

FIG. 2 is a series of mechanical elevational views of the tool constructed in accordance with a preferred embodiment of the invention;

FIG. 3 is a series of two perspective views of the tool with the safety guard in its two positions constructed in accordance with a preferred embodiment of the invention depicted in use;

FIG. 4 is a perspective overhead view of the tool constructed in accordance with a preferred embodiment of the invention;

### DETAILED DESCRIPTION OF THE PREFERRED EMBODIMENTS

The invention is generally directed so an acoustical ceiling tile cutting tool which is designed to cut the relief or rebate in a tile which has been trimmed for use in a dropped ceiling. The installation of a dropped ceiling generally requires a series of steps. First, the framework dropped ceiling must be installed in a room a set distance from the true ceiling such that a level ceiling can be provided below the true ceiling which hides duet work, electrical cables, lighting fixtures and the like so as to provide a clean apparent ceiling within the room of finished appearance. The framework is generally designed to support acoustical ceiling tiles of a given dimension. In most cases these are either two foot square or two foot by four foot rectangular tiles except around the perimeter of the room where smaller and angled tile pieces are required to complete the ceiling. Generally, after the support structure for the dropped ceiling is installed the full sized tiles are merely placed within the framework and supported around their perimeter by the support structure which has a perimeter area around the tile which is cut back into a relief or rebate so that the central portion of the tile hangs below the bottom of the metal framework of the dropped ceiling. This provides a clean and regular ceiling surface when viewed from below. However, where the support structure approaches the perimeter of the room or irregularly shaped areas of the room, there is a need to provide smaller than full tiles. Generally, when an acoustical ceiling tile is provided from the manufacturer, it comes with a relief or rebate area around all four sides of the square tile. However, whenever tile is cut down in size to fit into the grid of the support structure, the side or sides which are cut do not have a relief or rebate. This relief area is necessary on all sides of the tile so that it hangs properly and flatly. To cut the relief it is necessary to cut both a depth and a height to the relief, which is generally a standard size for a particular tile. Generally, the height and depth are equal, but, depending upon the nature of the installation, it can vary.

To cut the relief one generally cut out a square cross-sectional portion of the tile along any edge which has been cut and subsequently the relief portion needs to be painted so as to match the color on the flat, bottom surface of the tile and the other preformed relief sections.

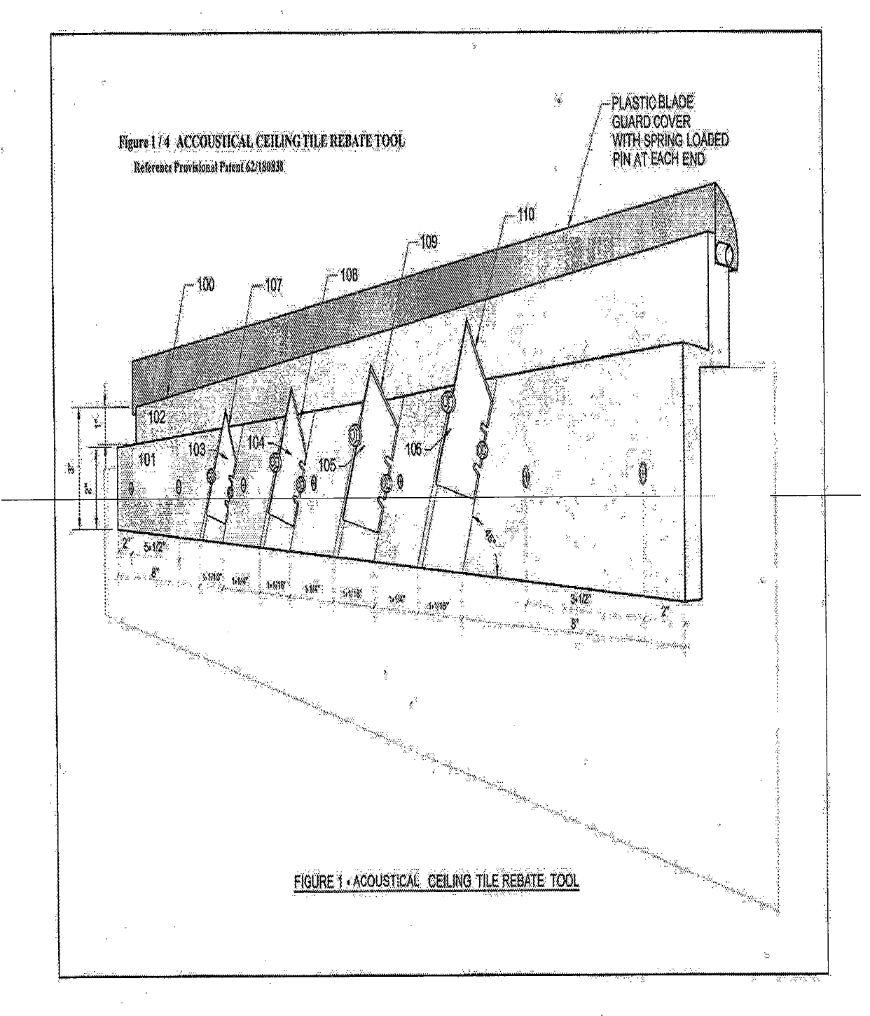

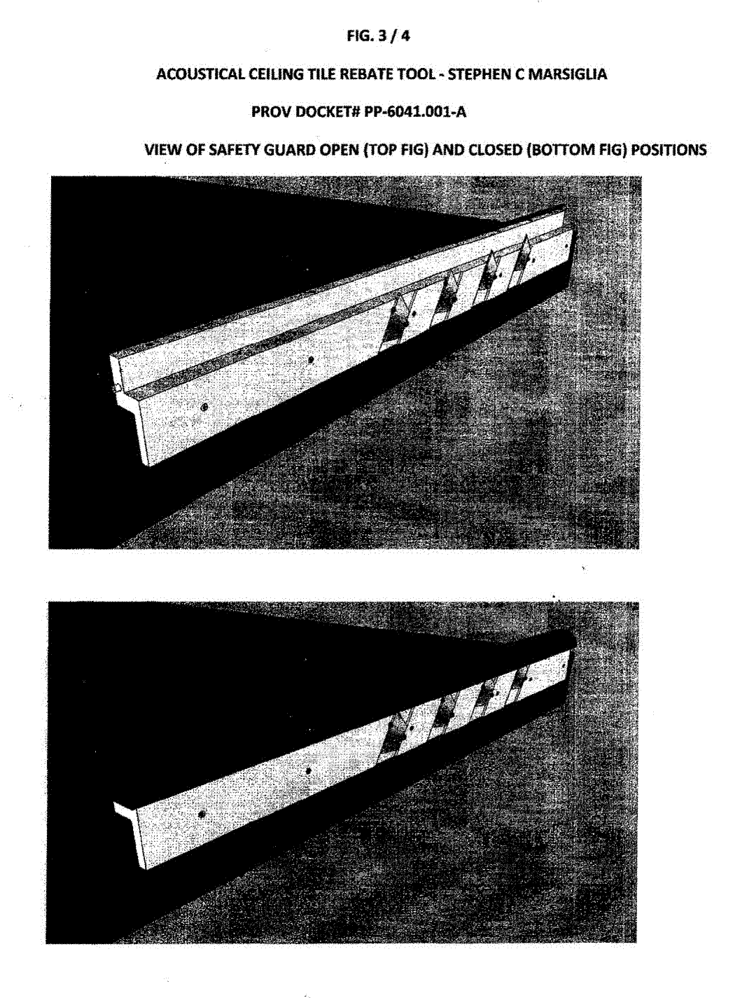

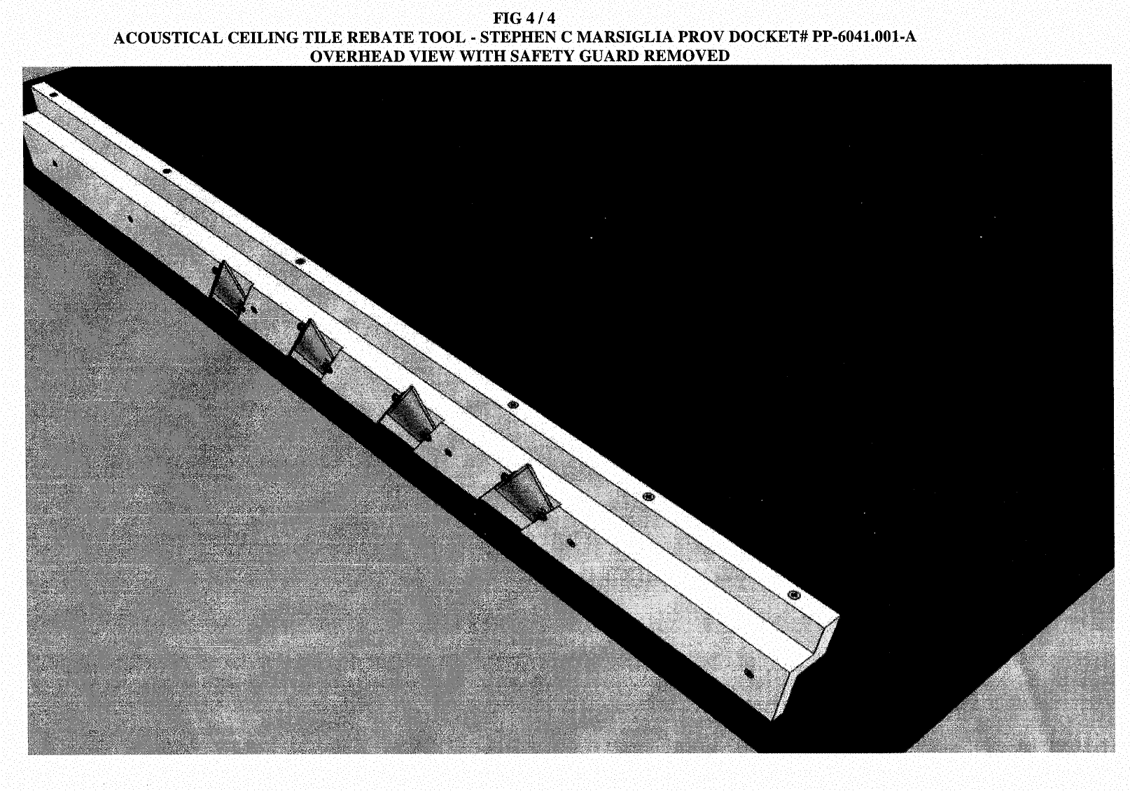

Reference is first made to FIGS. 1, 2, 3, and 4, which show the tool 100, including lower support member 101 and upper or back support 102, as well as cutting blades 103, 104, 105 and 106. The cutting blades 103, 104, 105 and 106 are contained within angled slots 107, 108, 109 and 110. Tool 100 is supported on and fixed to bench 50. As can be seen in the top part of FIG. 3, a hood can be swung out of the way when the tool is in use and hood the blades 103, 104, 105 and 106 when not in use as shown in the lower part of FIG. 3 to protect against inadvertently cutting oneself on the sharp blades. The hood is spring loaded so that it will swing into the safety position when the tool is not in use, but will stay in the clear position as shown in the upper part of FIG. 3 when in use.

Tool 100 includes a lower support member 101, which holds blades 103, 104, 105 and 106 and an upper or back guide member 102, which is used to properly position the edge of an acoustical tile as it is drawn through the tool 100. The four blades 103, 104, 105 and 106 are arrayed in a fashion whereby the leading edge of the acoustical tile will contact them in the order of knife 103, then knife 104, then knife 105 and finally knife 106. The tips of the knife blades are staggered such that blade 103 extends only barely above the base 101, with each subsequent blade extending further upwardly from the top surface of support 101 such that blade 106 provides the final height of the cut that is made. Generally, a tile is pushed twice through the blade area of tool 100 to first cut the height and then the depth of the relief cut onto an edge of an acoustical tile. Alternatively, the tile can be pushed through in a fashion whereby the first cut is the depth followed by the height of the relief. Generally these two cuts are of close to equal dimension such that the portion of the acoustical tile removed by the two cuts would be of equal length, making the portion removed a generally square cross-section along the length of the side being cut.

By having multiple blades, each of which cuts freshly only a portion of the cut being made, much less resistance is provided when the acoustical tile is pulled along the guide formed by the top of base portion 101 and the side of top portion 102 and the life of the blades before they become dull and require replacement is similarly extended.

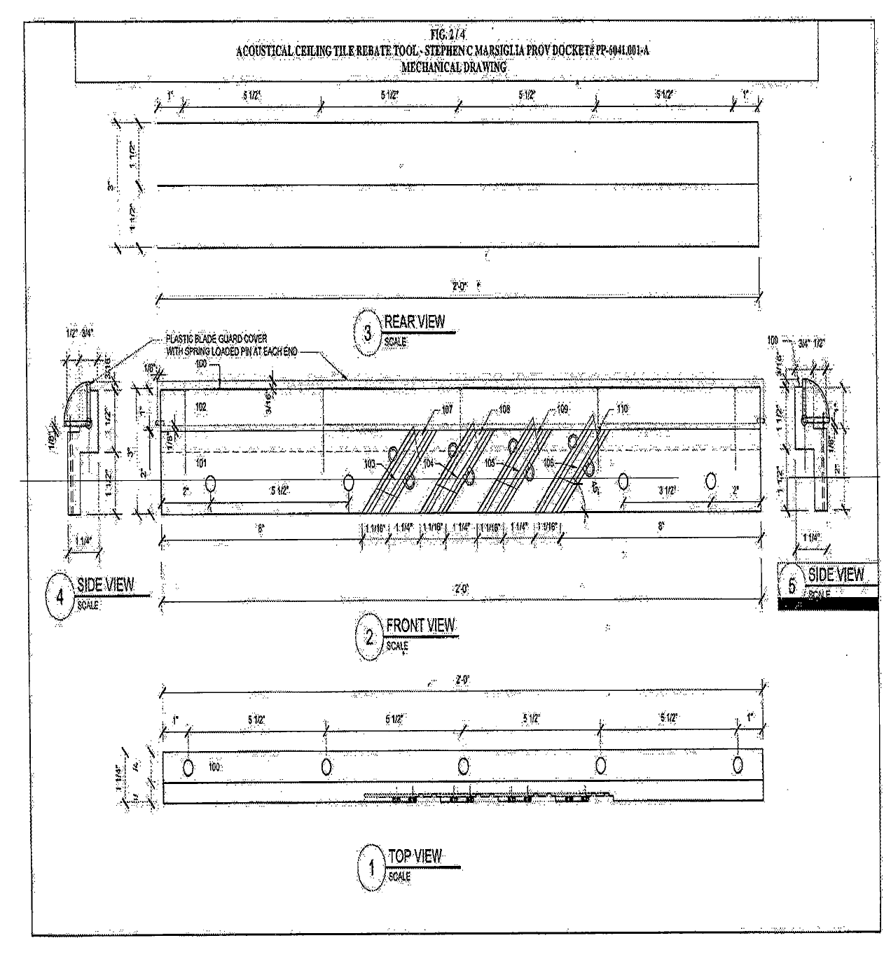

FIG. 2 shows a series of elevational views of the tool 100 from each side and from the end. This side view figure shows the way the hood fits is over the blades.

The terminology that is utilized in this area includes the term suspended ceiling, acoustical ceiling tile and recessed edge.

A suspended or dropped ceiling is a metal grid that hangs down below the actual unfinished ceiling in a room. The grid is filled with acoustical ceiling tiles that give a finished look to a room while still allowing for all of the mechanicals needed to run a building to be placed above it. Because the tiles pop in and out they allow tor easy access for repairs and upgrades. This is why you see them in most every commercial space in the world. Suspended ceilings as we know them have been around since the mid-1 950s. Their value is in esthetics, noise reduction, and easy versatility of installation.

Acoustic ceiling tiles are the tiles made of a fibrous material that sit in the suspended ceiling grid. They are usually two feet by four feet or, more commonly, two feet by two feet and can either sit on top of the metal grid or drop down into the grid. Most commercial ceilings have drop in tiles as they are much nicer looking and apparently afford even more sound reduction because they extend beyond the bottom of the grid and can, therefore, be more disruptive to sound waves, as well as increasing their sound absorption factor. The drop down into a grid ceiling tile must have a recessed edge on all four sides.

The indented edge around the suspended acoustical ceiling tile is called the recess, relief or the rebate. It allows for the ceiling tile to drop down into place on the ceiling metal grid for a better appearance with the added function, while still being supported by the grid.

When the dropped ceiling is installed properly, it must be made from the center out so that the square tiles look balanced from both the length and width of the room. The idea is to achieve a tile in the center of the room from both directions so unless you have perfectly square rooms in two or four foot increments you will have to cut the perimeter tiles to a size other than two by four or two by two. Once a tile is cut it loses its rebate and a new one must be cut in so that the partial tile will drop into place on the grid The tool constructed in accordance with the invention achieves this in a quick, accurate and safe way.

Previously, to cut in a rebate, there were two options. Option one was a small hand-held unit with a single blade that worked against the tile from the top and then the side to slice out a rebate. Generally, and an experienced ceiling mechanic can cut out a rebate with this of tool in about one or two minutes. A hand-held tool is difficult to use and many times requires multiple passes to achieve a clean cut. Also, working tool against the tile is less desirable than working the tile against the tool. Because the hand-held has only a single cutting blade, the blade wears out four times faster and cuts at least ten times slower than a multi-bladed array with four blades. The second option was a cutter mounted on rails that slides down the tile as if it were being routed. This tool is relatively expensive, can be cumbersome and not conducive to use in the field where almost all ceiling installations are performed.

The tool in accordance with the invention herein addresses the factors above by providing an affordable unit that is installed on any flat-square surface and uses a pre-routed jig upon which graduated utility knife blades are mounted, as shown in FIGS. 1-4. The blades are adjustable to accommodate different rebate heights and widths. The tool uses four blades in a graduated array starting very low and then gradually increasing in cutting height until the blade, which is adjusted to the actual height of the rebate needed. The area behind the blade is a precision routed channel that guides the tile squarely and evenly so that, as it is pulled across the blades, the cutting width and height remain constant.

Additionally, the use of multiple cutting blades in graduated array splits the cutting work into fourths for each blade, thus making for less wear and stress on each blade and, therefore, requiring less changing of worn blades. The tool is designed to accept standard utility knife blades, thus decreasing the cost of producing and making it more user friendly, because replacement blades can generally be found anywhere. The cost is also reduced because of the ready availability of standard utility blades.

In addition, to making the blade height adjustable in order to accommodate rebates of different heights, the routed channel can be adjusted well by the adjustment of the back rail 102 in an out to accommodate different depths. By doing these two adjustments any ceiling tile rebate can be duplicated.

The tool 100 is used by first mounting the tool on a flat, square surface like a workbench or portable saw bench. Then the blades are adjusted to graduate to the ultimate depth of the ceiling tile being used. Finally, one adjust the back guide to the depth needed for a tile so that the appropriate rebate can be cut. Next the ceiling tile is cut to the size of the opening in the grid that it will fill, plus the depth of the area between the blades and the back guide of the tool. This will allow for the tile to drop in and still have an area above the cut side of the grid on which to rest. Next one passes the tile face down with the cut up against the back guide of the tool. This will give the appropriate height for the rebate. Next, one rotates the tile 90 degrees and passes it over the blades again the back of the tile pressed against the tool back guide. This will give the appropriate depth of the rebate. Finally, one cleans off any excess with a dry brush (not shown), and one colors the base rebate with bright white latex paint of other color matching the surface of the tile. After the paint dries the tile is placed in its appropriate spot in the grid.

By passing the tile over the blades there is a much higher degree of stability and accuracy than by passing the hand-held tool over the tile. Two passes, 90 degrees apart in orientation and the rebate is formed in less than 10 seconds.

The tool can be made in a number of ways. The longer the length, the more stable the guide can pull through the tile. Two feet long is an optimal length, but the tool can be made shorter to fit into a tool box for greater portability. Also, height of between 3 and 5 inches is suitable with a height of 3% being more desirable. The dimensions can be made taller or shorter to accommodate needs for greater economy during manufacture or specific requirements of use. The tool can be silk screened with instructions and side calibrations to allow easy adjustment of the blade array and the back guide. In further embodiments the tool will also have warning colors and warnings in two languages regarding the danger from the blade array. As ceiling mechanics may speak several languages, the warnings can be added in appropriate languages for the usage expected. In addition, the blade array can have a spring-loaded plastic snap-over shown in FIG. 3 to protect the blades from damage, as well as to protect users from inadvertently touching the upright blades and being cut when the tool is not in use. The default position of the hood will be over the blades. Pressing a tile against the corner will rotate the hood to the back of the tool exposing the blades for cutting. As the end of the tile leaves the tool the hood will snap back to cover the blades. The tool also has a vacuum attachment, not shown, that collects the dust that is produced as the tile is being sliced. There are also shallow grooves cut behind the mounted blades to allow for dust to fall and not interfere with a clean, frictionless cut by the blades.

The tool can be manufactured form 5/4 by 3 and ¾ inch PVC stock that is precision routed and then precision drilled for mounting holes and for holes to house pan-head screws to retain the individual blades. The tool can also be manufactured by blow molding or injection molding with screw channels for a mounting and threaded metal inserts to accommodate the blade retaining screws. Because it is a blow molded or injection molded plastic, the tool can be color coded to exemplify caution against inadvertent injury from cutting oneself on the blades.

Accordingly, the tool constructed in accordance with the invention cuts the rebate on the ceiling tile faster, more accurately and more safely.

It will thus be seen that the objects set forth above, among those made apparent in the preceding description, are efficiently obtained, and, since certain changes may be made in the above construction without departing from the spirit and scope of the invention, it is intended that all matter contained in the above description or shown in the accompanying drawings shall be interpreted as illustrative, and not in a limiting sense.

It is also understood that the following claims are intended to cover all of the generic and specific features of the invention, herein described are all statements the scope of the invention, which, as a matter of language, might be said to fall there between.

What is claimed is:

1. An acoustical ceiling tile rebate cutting tool comprising:
a bottom support member;
a back support member;
a series of graduated height knives fixed to the base support member for cutting a rebate in an acoustical ceiling tile.

2. The Acoustical ceiling tile rebate cutting tool of claim 1, wherein the tool includes a spring loaded snap over plastic hood to protect the user from injury due to exposed blades when not in use.
